(19) United States
(12) Patent Application Publication
(10) Pub. No.: US 2008/0024804 A1
(43) Pub. Date: Jan. 31, 2008

(54) Image data output device, printing device, printing system, image data output program and its installation program

(75) Inventors: Tsuyoshi Yamanaka, Komaki-shi (JP); Yuji Miyata, Kitanagoya-shi (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/826,863

(22) Filed: Jul. 19, 2007

(30) Foreign Application Priority Data
Jul. 25, 2006 (JP) 2006-202091

(51) Int. Cl. G06F 15/00

(52) U.S. Cl. 358/1.9

(57) ABSTRACT

An image data output device includes, a setting part that can set adjustment values, an adjusting part that can adjust the image quality of image data based on the adjustment values, a choosing part that can choose the image data, a display part that can display an image to preview adjustment effects for the image data chosen by the choosing part, the image quality has been adjusted by said adjusting part, and a data outputting part that can output the image data to be a print target to the printing device, wherein the image quality of the image data has been adjusted by said adjusting part.

### CROSS REFERENCE TO RELATED APPLICATION

This application claims priority from Japanese Patent Application No. 2006-202091 filed Jul. 25, 2006. The entire content of this priority application is incorporated herein by reference.

### TECHNICAL FIELD

The present disclosure relates to an image data output device, a printing device, a printing system, an image data output program and its installation program.

### BACKGROUND

In recent years, a technique has been proposed that allows a user to adjust the image quality of an image to be outputted on a PC when outputting the image data to a printing device (such as a color printer) to print the image data. The technique works to allow, for example, the user to previously save multiple sets of image quality adjustment values (parameters) of various types through a printer driver; if the user selects a desired set of image quality adjustment values to execute the printing, image data is adjusted depending on the selected image quality adjustment values and printing is performed based on the adjustment.

There is also another technique known to realize the following. That is, if a sample image is prepared beforehand in a printer driver, the image quality of the sample image is adjusted for display depending on image quality adjustment values when a user inputs the values, so that the result (effects) of the printing by the user using the image quality adjustment values can be easily exhibited.

However, in accordance with the above techniques, effects of the image quality adjustment on image data that a user actually desires to print are not always appropriately exhibited since a predetermined sample image is used for the image quality adjustment.

In view of the above circumstances there is a need in the art for an image data output device, a printing device, a printing system, an image data output program and its installation program that can perform the image quality adjustment more appropriately.

### SUMMARY

According to one illustrative aspect of the present invention, an image data output device includes, a setting part that can set adjustment values, an adjusting part that adjusts the image quality of image data based on the adjustment values being set by the setting part, a choosing part that can choose the image data, a display part that can display an image to preview adjustment effects for the image data chosen by the choosing part, wherein the image quality has been adjusted by the adjusting part, and a data outputting part can output the image data to be a print target to the printing device, and the image quality of the image data has been adjusted by the adjusting part.

### BRIEF DESCRIPTION OF THE DRAWINGS

Illustrative aspects in accordance with the invention will be described in detail with reference to the following figures wherein:

FIG. 1 is a block diagram showing system configuration in accordance with an illustrative aspect of the present invention;

FIG. 2 is a flowchart showing the flow of print processing by a printer driver;

FIG. 3 is a diagram illustrating detailed parameter setting values;

FIG. 4 is a diagram showing a print setting screen;

FIG. 5 is a diagram illustrating contents of saved data;

FIG. 6 is a flowchart showing the flow of custom setting processing;

FIG. 7 is a flowchart showing the flow of the custom setting processing;

FIG. 8 is a diagram showing a custom setting screen;

FIG. 9 is a flowchart showing the flow of export processing;

FIG. 10 is a diagram briefly illustrating contents of a setting information file;

FIG. 11 is a flowchart showing the flow of import processing; and

FIG. 12 is a flowchart showing the flow of an installation processing by an installation program.

### DETAILED DESCRIPTION OF THE PREFERRED ILLUSTRATIVE ASPECTS

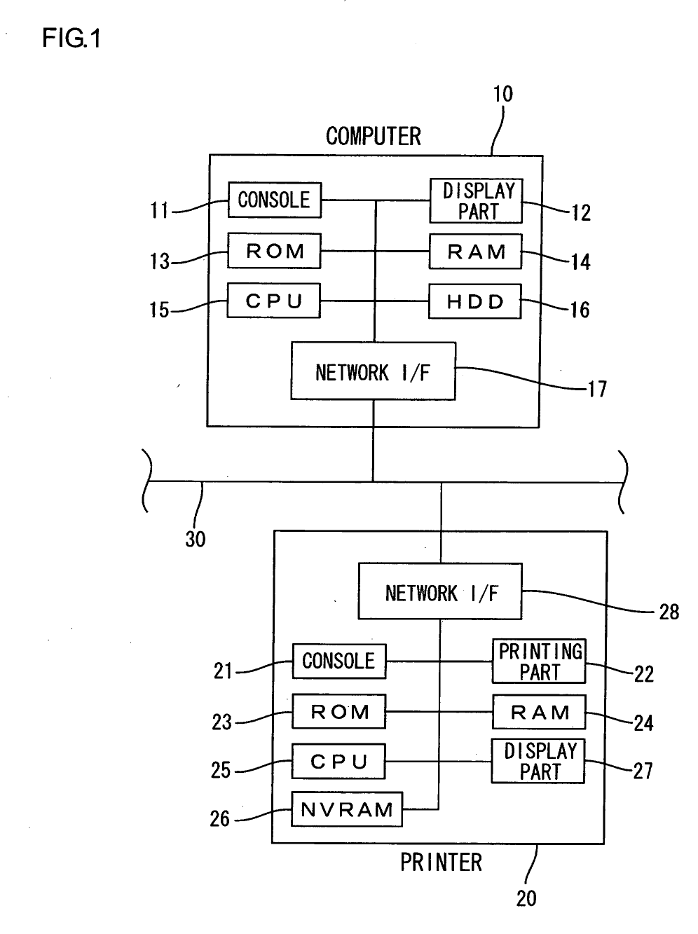

An illustrative aspect of the present invention will be described with reference to FIGS. 1 to 12.

1. General Configuration

FIG. 1 is a block diagram showing the configuration of a printing system in accordance with this illustrative aspect. As shown in the drawing, the printing system consists of one or more computers (an example of image data output devices) and one or more printers (an example of printing devices) connected via a network 30 such as a LAN.

(Computer)

A computer 10 is configured to comprise a console 11 (an example of a “setting part” or a “choosing part”) for accepting an input operation from the outside such as a keyboard or a mouse, a display part 12 (an example of a “display part”) such as an LCD display, a ROM 13, a RAM 14, a CPU 15 (an example of an “adjusting part”, a “setting information outputting part”, a “setting information inputting part” or a “trial printing part”), a memory or a hard disk drive 16 (an example of a “saving part”), a network interface 17 (an example of a “data outputting part”) and the like. The hard disk drive 16 stores a printer driver (an example of an “image data output program”) or other application software described below. The CPU 15 reads out the printer driver and others from the hard disk drive 16 for execution based on an execution direction from the console 11.

(Printer)

A printer 20 is configured to comprise a console 21 consisting of various types of keys and others, a printing part 22 (an example of a “printing part”) for printing on a recording medium (such as a paper sheet), a ROM 23, a RAM 24, a CPU 25, a NVRAM (non-volatile memory) 26 (an example of a “storage region”), a display part 27 such as an LCD display, a network interface 28 and the like. The CPU 25 controls the other parts in accordance with a program stored in the ROM 23.

2. Detailed Processing by a Printer Driver

(Print Processing)

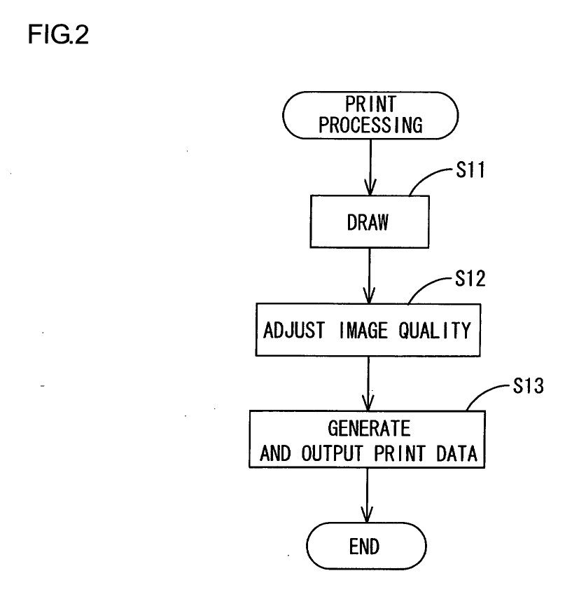

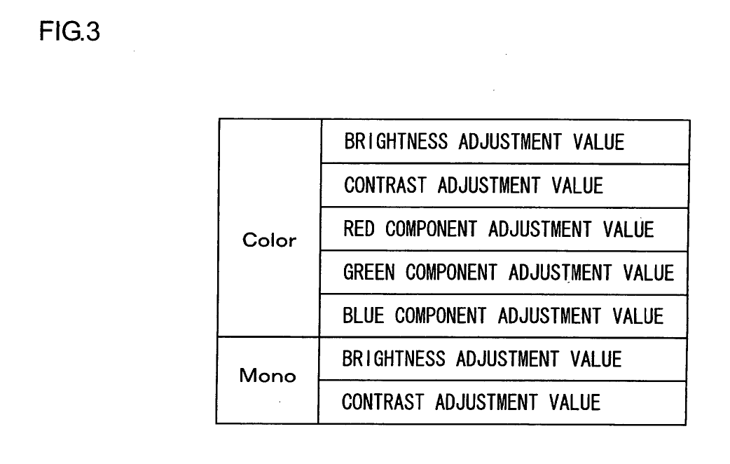

FIG. 2 is a flowchart showing the flow of print processing, while FIG. 3 is a diagram illustrating detailed parameter setting values. When a user inputs a print indication using the console 11, a printer driver is loaded onto the RAM 14 in accordance with control by the CPU 15 and executes the print processing. When the CPU 15 starts the print processing, first it reads data (composed of objects such as a text, a figure or a photograph) to be printed and performs drawing processing to generate image data in a bit map format based on the data (S11).

Subsequently, the image quality of the image data is adjusted based on parameter setting values stored on the hard disk drive 16 (S12). The parameter setting values are set in print setting processing described below. The parameter setting values (a set of adjustment values) can corresponding to various parameters to adjust the image quality of brightness, contrast, a red component, a green component and a blue component in the case of color, while it include adjustment values (a set of adjustment values) corresponding to two parameters of brightness and contrast in the case of monochrome, as shown in FIG. 3.

Next, image data with adjusted image quality undergoes processing such as color conversion to convert RGB data into CMYK data or compression, for example, to generate print data, and then the print data is sent and outputted to the printer 20 via the network interface 17 (S13). When the printer 20 receives the print data, it prints and outputs an image corresponding to the print data on a recording medium using the printing part 22.

(Print Setting Processing)

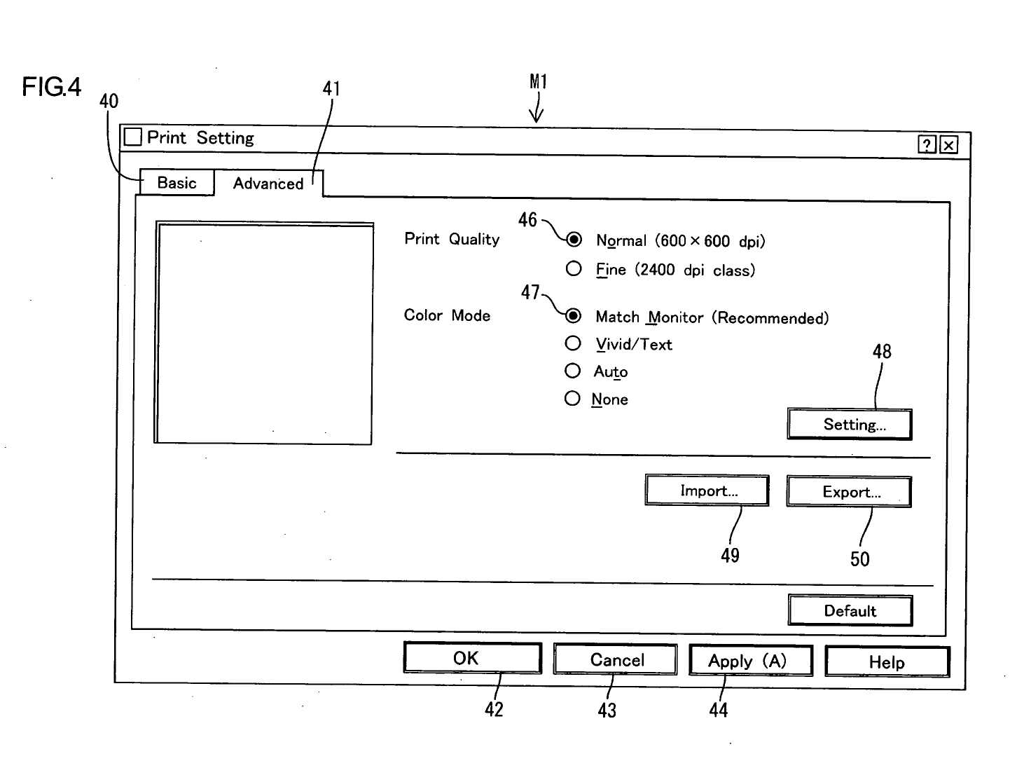

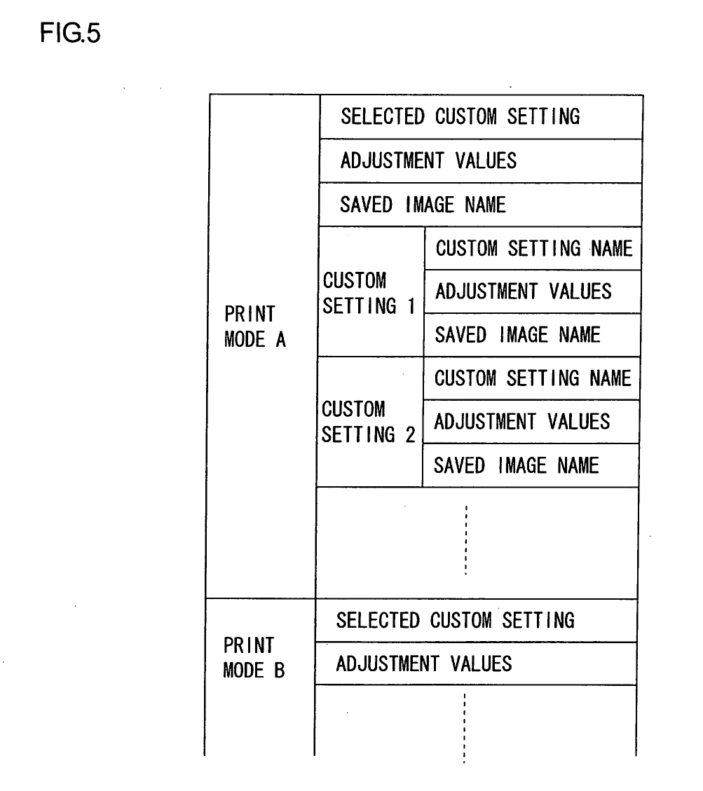

FIG. 4 is a diagram showing a print setting screen Ml, while FIG. 5 is a diagram illustrating contents of saved data. When the user inputs a print setting direction from the console 11 in accordance with the control by the CPU 15, the printer driver is loaded onto the RAM 14, executes the print setting processing, and displays the print setting screen M1 shown in FIG. 4 on the display part 12. The print setting screen M1 is configured to display a basic setting tab 40 and an advanced function tab 41 by switching between them. At the bottom of the screen, there are provided an OK button 42, a cancel button 43, an apply button 44 and the like.

On the basic setting tab 40, there are provided setting items such as the paper sheet size, layout, the number of copies and color/monochrome, although not shown in detail. On the advanced function tab 41, there are provided two option buttons 46 to select the resolution, four option buttons 47 to select a color mode, a custom setting button 48, an import button 49, an export button 50 and the like.

In this aspect, driver setting information used by the printer driver is stored on the hard disk 16. The driver setting information contains the above described parameter setting values used in the print processing as shown in FIG. 3 or saved data shown in FIG. 5. The saved data contains information of a set of adjustment values corresponding to multiple kinds of print modes selected based on a combination of settings of color/monochrome, resolution and a color mode that can be selected in the print setting processing. The saved data also contains custom setting selected for each of the print modes, a saved image name of image data (including position information of the image data) used for display of an image to preview adjustment effects, as well as a custom setting name, a set of adjustment values and a saved image name of the image data corresponding to the custom setting saved for each of the print modes, whose details will be described below.

When the apply button 44 is clicked on the print setting screen M1, setting details of the setting items are established. At this time, adjustment values in a set of adjustment values corresponding to a print mode selected by a user are read from the saved data and set as parameter setting values.

When the OK button 42 is clicked on the print setting screen M1, the setting detail of setting items are established, the screen closes, and the print setting processing ends. Otherwise, when the cancel button 43 is clicked, the setting details are not established and the print setting processing ends. An operation when the custom setting button 48, the import button 49 or the export button 50 is clicked will be described below.

(Custom Setting Processing)

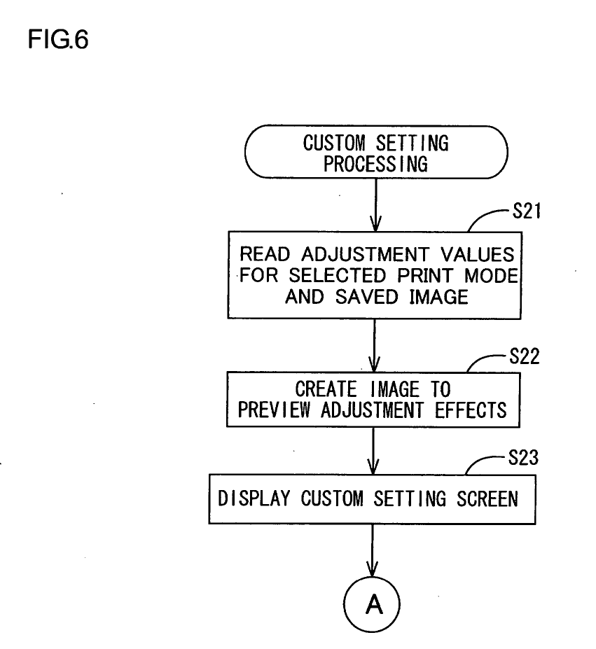

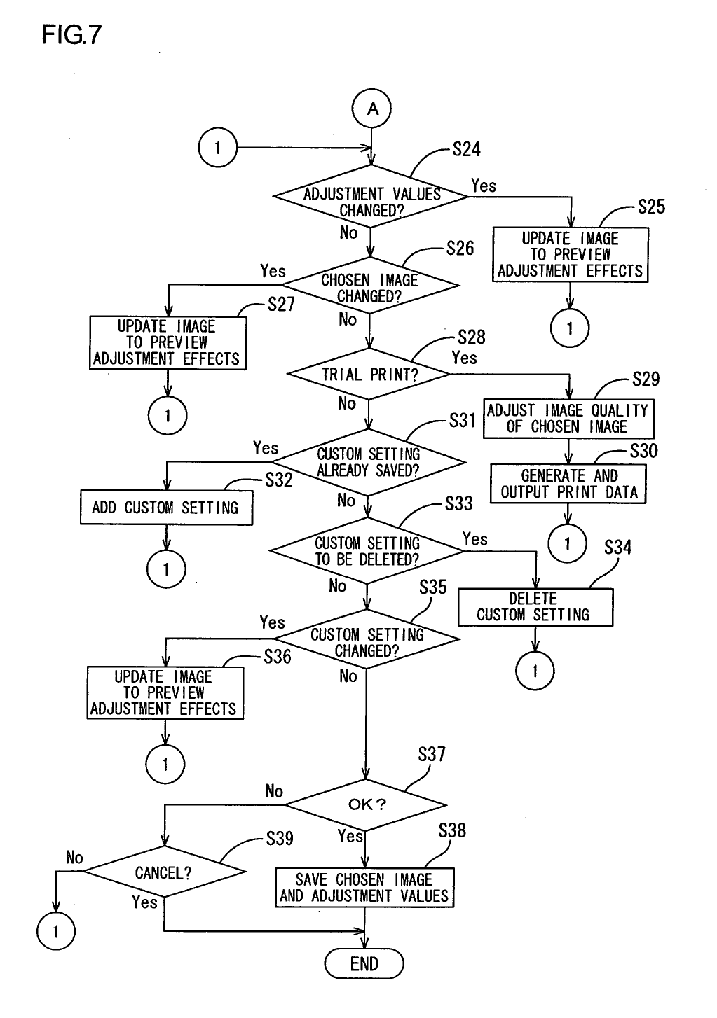

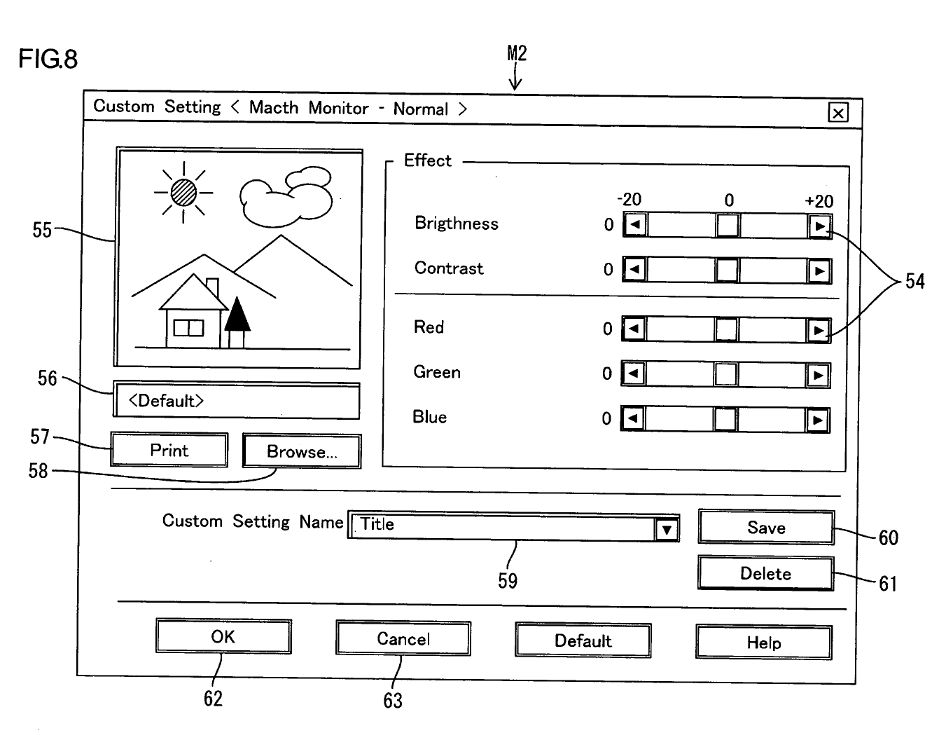

FIGS. 6 and 7 are flowcharts showing the flow of custom setting processing, while FIG. 8 is a diagram showing a custom setting screen. When the custom setting button 48 is clicked on the print setting screen Ml, the following custom setting processing is executed. In the custom setting processing, first adjustment values corresponding to a current selected print mode and image data corresponding to a saved image name are read with reference to the saved data as described above (S21). Subsequently, the image is adjusted based on the adjustment values read for the saved image data, and image data is created for display of an image to preview adjustment effects described below (S22).

Next, a custom setting screen M2 shown in FIG. 8 is displayed on the display part 12 (S23). On the upper right of the custom setting screen M2, there are provided five scroll bars 54 to set parameters of brightness, contrast, a red component, a green component and a blue component. On the left, there are provided an image display portion 55 to display an image to preview adjustment effects. On the lower part, there is provided a name display portion 56 to display a name of the image to preview adjustment effects. The image display portion 55 is configured to display an image with adjusted image quality of image data that has been chosen (chosen image data). Immediately after the custom setting screen M2 is displayed, the portion 55 displays an image based on the image data created at S22 as described above. Under the name display portion 56, there are provided a trial print button 57 to print an image according to preview adjustment effects and a browse button 58 to change the image.

Further, in the lower part of the custom setting screen M2, a list display portion 59 is provided. The portion 59 is configured to list and display all custom setting names saved as the above described saved data for a selected print mode. Additionally, in the list display portion 59, characters can be inputted and one of the listed and displayed custom setting names can be selected. On the right of the list display portion 59, there are provided a save button 60 to save custom setting and a delete button 61 to delete custom setting. At the bottom of the custom setting screen M2, there are provided an OK button 62, a cancel button 63 and other buttons.

If the positions of the scroll bars 54 are changed while the custom setting screen M2 is displayed (S24: Yes), the image quality of chosen image data (original data of an image being currently displayed in the image display portion 55) is adjusted based on adjustment values corresponding to the changed positions. Then, an image subjected to the image quality adjustment is displayed as an image to preview adjustment effects in the image display portion 55 (S25).

If the browse button 58 is clicked on the custom setting screen M2, a dialog (not shown) to designate the position of image data is displayed. A user can arbitrarily choose image data recorded on the hard disk 16 or other computers 10 connected to the network 30 through the dialog. When image data is chosen (S26: Yes), the image data is read, the image quality is adjusted based on adjustment values being currently set, an image subjected to the image quality adjustment is displayed as an image to preview adjustment effects in the image display portion 55, and a name of the image data is displayed in the name display portion 56 (S27).

If the trial print button 57 is clicked (S28: Yes), the image quality is adjusted for chosen image data based on adjustment values being currently set (S29), print data is generated based on image data subjected to the image quality adjustment, and the print data is outputted to the printer 20 via the network interface 17 (S30). When the printer 20 receives the print data, it prints and outputs an image corresponding to the print data (i.e., an image corresponding to an image to preview adjustment effects) on a recording medium through the printing part 22.

If certain characters are inputted as a custom setting name to the list display portion 59 and the save button 60 is clicked (S31: Yes), then the inputted custom setting name, and its correlated print mode being currently selected, chosen image name and adjustment values are added to the saved data described above (S32). If there is already the same custom setting name when the save button 60 is clicked (S31: Yes), then the above saved data is updated with that custom setting name and its correlated print mode being currently selected, chosen image name and adjustment values (S32). If the delete button 61 is clicked (S33), custom setting information corresponding to a custom setting name being currently displayed in the list display portion 59 is deleted from saved data (S34).

If one of custom setting names, being in an unselected state, is selected in the list display portion 59, or the selected custom setting name is changed in the portion 59 (S35: Yes), then adjustment values and a saved image name corresponding to the selected custom setting name are read from saved data, the image quality is adjusted based on the adjustment values read for the saved image data, and an image after the image quality adjustment is displayed as an image to preview adjustment effects in the image display portion 55 (S36)

If the OK button 62 is clicked on the custom setting screen M2 (S37: Yes), then adjustment values being set through the scroll bars are saved as adjustment values for the print mode to saved data, a name of the chosen image being currently displayed in the image display portion 55 is saved as a saved image name for the print mode to saved data, and custom setting being currently selected is saved as selective custom setting to the saved data (S38). Then, the custom setting processing ends and returns to the print setting screen M1. If the cancel button 63 is clicked (S39: Yes), adjustment values are not saved and the custom setting processing ends and returns to the print setting screen M1.

(Export Processing)

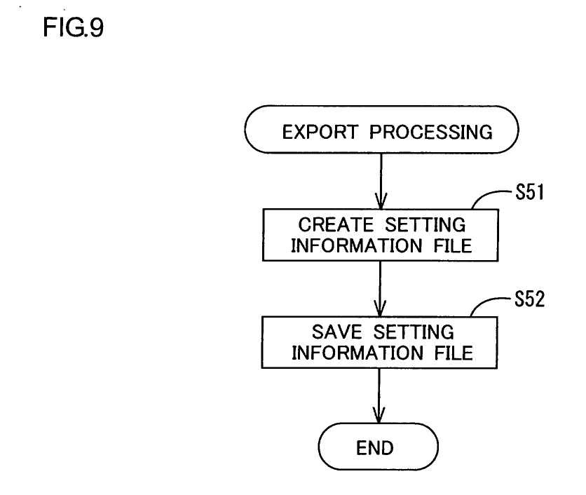

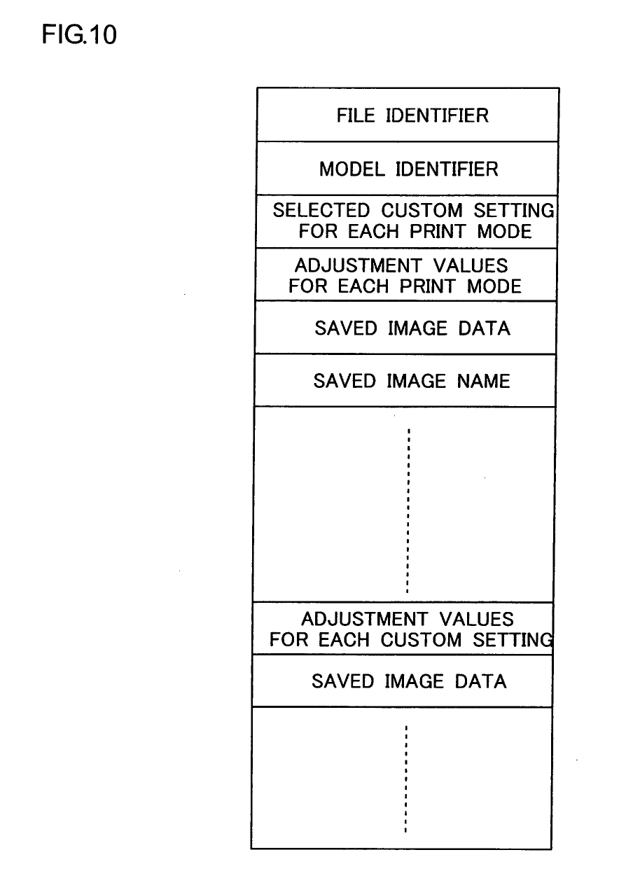

FIG. 9 is a flowchart showing the flow of export processing, while FIG. 10 is a diagram briefly illustrating contents of a detailed setting information file. If the export button 50 is clicked on the print setting screen Ml, the export processing is executed.

In the export processing, first a setting information file described below is created with reference to saved data (S51). A setting information file has, for example, structure as shown in FIG. 10. As shown in the drawing, the file comprises a file identifier to indicate that it is a setting information file, and a model identifier to indicate a printer model corresponding to a printer driver for creating a setting information file (an example of “identification information”). A setting information file further comprises selected custom setting for each of print modes, an adjustment value set corresponding to the print mode, a saved image name corresponding to the print mode, and saved image data (bit map data) corresponding to the print mode. A file further comprises an adjustment value set corresponding to saved custom setting, and saved image data (bit map data) corresponding to the custom setting.

After a setting information file as described above is created, a dialog (not shown) to designate a destination for saving (outputting) is displayed. If a user designates a destination for saving, a setting information file is saved (S52). As a destination for saving, for example, the hard disk drive 16 of the computer 10, hard disks of other computers connected to the network 30, or a region on the NVRAM 26 of the printer 20 can be designated. Then, the export processing ends and returns to the print setting screen Ml.

(Import Processing)

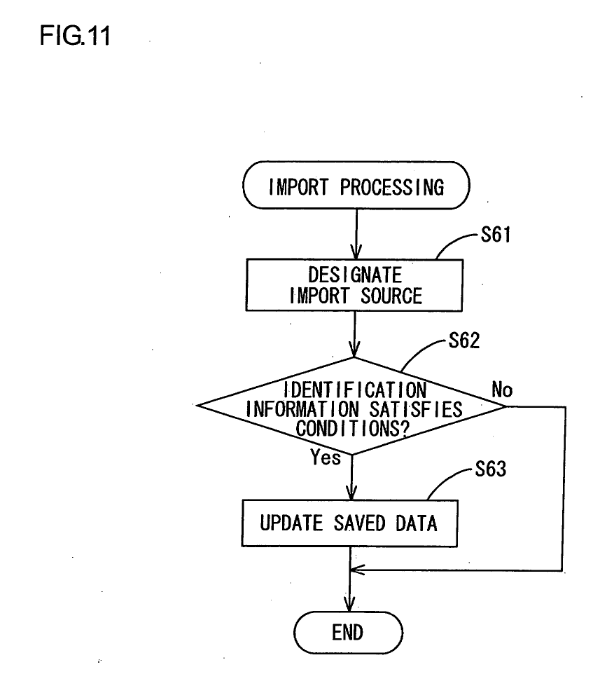

FIG. 11 is a flowchart showing the flow of import processing. If the import button 49 is clicked on the print setting screen M1, the import processing is executed. In the import processing, first a dialog (not shown) to designate the location of a setting information file being an import source is displayed (S61). As an import source, for example, the hard disk drive 16 of the computer 10, hard disks of other computers connected to the network 30, or a region on the NVRAM 26 of the printer 20 can be designated.

Subsequently, a file identifier and a model identifier of a designated setting information file are checked. Then it is determined whether or not the identifiers satisfy prescribed conditions (i.e., whether or not the designated file is a setting information file and its model information is for a model which the printer driver is compatible with) (S62). If the setting information file satisfies the prescribed conditions (S62: Yes), contents of saved data are rewritten based on contents of the setting information file (S63) . Then, the import processing ends to return to the print setting screen Ml. If the setting information file does not satisfy the prescribed conditions (S62: No), the saved data is not updated and the import processing ends to return to the print setting screen Ml. 3. Processing of a Printer Driver Installation Program

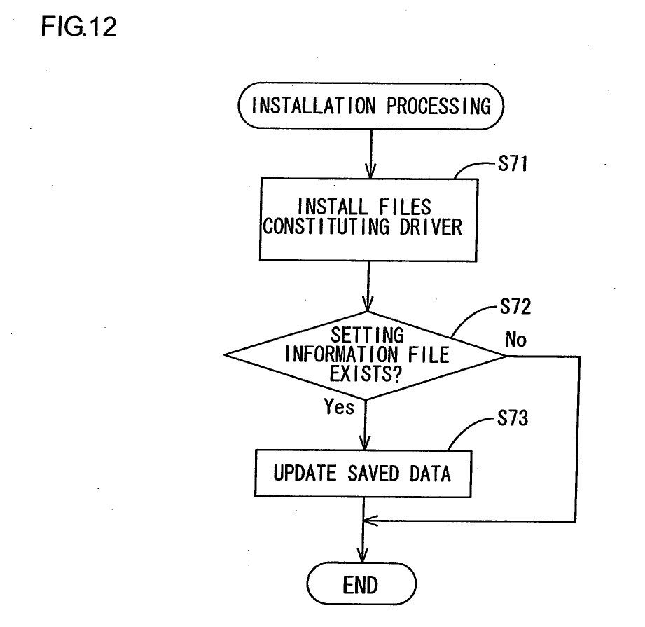

Next, processing of an installation program to install the above printer driver on a computer (an example of an “installation program for an image data output program”) will be described. FIG. 12 is a flowchart showing the flow of the installation processing of the installation program.

The installation program, which is stored on the hard disk drive 16 of the computer 10, on hard disks of other computers on the network 30 or on the NVRAM 26 of the printer 20, is loaded on the RAM 14 through control by the CPU 15, whereby the program is started up and executes the following installation processing.

In the installation processing, files constituting the printer driver are first installed on the hard disk 16 (S71). Next, it is checked whether or not a setting information file is on a predetermined location (S72). A predetermined location can be, for example, in the same directory as an installation program or a predetermined location on the hard disk drive 16, or can be designated arbitrarily by a user.

If there is a setting information file (S72: Yes), then saved data of driver setting information stored on the hard disk 16 is rewritten based on contents of the setting information file (S73) and the installation processing ends. If there is no setting information (S72: No), saved data is not rewritten and the installation processing ends.

As described above, in accordance with this illustrative aspect, an image chosen arbitrarily by a user can be displayed to preview effects of the image quality adjustment, thereby allowing more appropriate adjustment of the image quality.

Conveniently, chosen image data can be saved, added to, changed and deleted.

Saved image data is stored in a state of being related with an adjustment value set; for example, saved image data and an adjustment value set corresponding to each kind of an image (text, photograph, logo or the like) are stored. As such, if an adjustment value set suitable for a kind of an image to be printed is selected upon printing, saved image data corresponding to the set is displayed as an image to preview adjustment effects, and thus the image quality can be easily adjusted.

Since there are provided functions to input and output (import and export) setting information, the same setting can be easily shared among a plurality of printer drivers.

The printer 20 can maintain setting information. As such, when a plurality of computers 10 share the same printer 20, the computers 10 can share the same setting far more easily.

Further, accidental or inappropriate settings can be prevented since setting information is restricted in use if identification information attached to the setting information does not satisfy prescribed conditions.

Setting information contains model information of the printer 20 as identification information, thereby preventing the same setting from being applied to other models of printers with different print features.

Since saved image data subjected to image quality adjustment, can be actually printed on a recording medium to preview effects of the image quality adjustment, the image quality can be adjusted more appropriately.

When a printer driver is installed, an adjustment value set and its corresponding saved image data are automatically saved, thereby making printer driver setting easy.

Though the above illustrative aspect has shown an example in which the computer 10 adjusts the image quality of image data to be a print target, a printing system can also be possible in which the printer 20 adjusts the image quality in accordance with the present invention. In that case, for example, the computer 10 adjusts the image quality of chosen image data through control by the CPU 15 (an example of a temporal adjusting part), but does not adjust the image quality for image data of a print target, and outputs the image data and image quality adjustment information such as parameter setting values to the printer 20. On the other hand, the printer 20 can be configured to adjust the image quality of image data received based on its image quality adjustment information through control by the CPU 25 (an example of an adjusting part) to create print data and to execute printing by the printing part 22.

Although the above illustrative aspect has described various parameters to adjust the image quality, other parameters such as saturation, color conversion, error diffusion, density or gradation, for example, other than the above examples can be used to adjust the image quality.

What is claimed is:

1. An image data output device comprising:
a setting part capable of setting adjustment values;
an adjusting part capable of adjusting the image quality of image data based on the set adjustment values;
a choosing part that is capable of choosing the image data;
a display part capable of displaying an image to preview adjustment effects for the image data chosen by said choosing part, wherein the image quality has been adjusted by said adjusting part; and
a data outputting part that outputs the image data to be a print target to a printing device, wherein the image quality of the image data has been adjusted by said adjusting part.

2. The image data output device in accordance with claim 1 comprising:
a saving part that capable of saving the image data chosen by said choosing part as saved image data, the saved image data is able to be added to, changed and deleted.

3. The image data output device in accordance with claim 2 wherein said setting part is capable of storing multiple sets of one or more of said adjustment values, and can set adjustment values in an adjustment value set selected from the adjustment value sets.

4. The image data output device in accordance with claim 3, wherein said saving part is able to relate said saved image data with said adjustment value set and stores the data.

5. The image data output device in accordance with claim 4 wherein said choosing part is able to choose saved image data corresponding to the adjustment value set selected by said setting part.

6. The image data output device in accordance with claim 5 wherein said display part is able to display an image to preview adjustment effects based on the saved image data.

7. The image data output device in accordance with claim 6, further including a setting information outputting part that is able to output setting information containing said adjustment value set and said saved image data related with the value set to the outside.

8. The image data output device in accordance with claim 7, wherein a setting information inputting part is able to cause said setting part to store said adjustment value set based on said setting information inputted from the outside, and said saving part to save said saved image data corresponding to the adjustment value set.

9. The image data output device in accordance with claim 8 wherein:
said setting information outputting part can output said setting information to a storage region in said printing device.

10. The image data output device in accordance with claim 8 wherein:
said setting information is attached with identification information, and said setting information inputting part does not cause said setting part to store said adjustment value set or said saving part to save said saved image data if said identification information does not satisfy prescribed conditions.

11. The image data output device in accordance with claim 10 wherein:
said identification information includes model information of said printing device.

12. The image data output device in accordance with claim 1 comprising:
a trial printing part that outputs said saved image data of the image quality adjusted by said adjusting part to said printing device using said data outputting part to execute the printing.

13. An image data output program comprising a computer connected to a printing device and a display part able to execute:
setting processing to set adjustment values;
adjusting processing to adjust the image quality of image data based on the adjustment values;
choosing processing to choose the image data;
displaying processing to display on the display part an image to preview adjustment effects for the image data chosen by said choosing part, wherein the image quality has been adjusted by said adjusting part; and
data outputting processing to output the image data to be a print target to said printing device to execute the printing, wherein the image quality of the image data has been adjusted by said adjusting part.

14. The image data output program in accordance with claim 13 wherein:
saving processing is executed to save the image data chosen by said choosing part as saved image data;
said setting processing can store multiple sets of one or more of said adjustment values, and can set adjustment values in an adjustment value set selected from the adjustment value sets;
said saving processing relates said saved image data with said adjustment value set and stores the data;
said choosing processing chooses saved image data corresponding to the adjustment value set selected by said setting processing; and
said displaying processing displays an image to preview adjustment effects based on the saved image data.

15. An installation program for an image data output program for causing a computer being said image data output device to execute:
installation processing to install said image data output program in accordance with claim 14; and auto saving processing to cause said setting part to store said adjustment value set based on setting information containing said adjustment value set and said saved image data related with the value set, and said saving part to save said saved image data corresponding to the adjustment value set.

16. A printing device connected to an image data output device comprising:
a setting part that can store multiple sets of one or more adjustment values, and set the adjustment values in an adjustment value set selected from the adjustment value sets;
an adjusting part that adjusts image quality of image data based on the adjustment values being set by said setting part;
a saving part that can relate the image data as saved image data with said adjustment value set and save the data;
a display part that displays an image to preview adjustment effects based on said saved image data corresponding to the adjustment value set selected by said setting part, wherein the image quality for the image data has been adjusted by said adjusting part;
a data outputting part that can output the image data to be a print target of the image quality adjusted by said adjusting part;
a setting information inputting part that causes said setting part to store said adjustment value set based on setting information containing said adjustment value set and said saved image data related with the adjustment value set, and said saving part to save said saved image data corresponding to the adjustment value set;
a printing part that can print the image data outputted from said data outputting part; and
a storage region that can store said setting information.

17. A printing system wherein an image data output device and a printing device are connected so as to be able to communicate with each other, wherein:
said image data output device comprises:
a setting part that can set adjustment values;
a choosing part that can choose image data;
a temporal adjusting part that can adjust the image quality of the image data chosen by said choosing part based on the adjustment values being set by said setting part;
a display part that can display an image to preview adjustment effects based on the image data of the image quality adjusted by said temporal adjusting part; and
a data outputting part that can output image quality adjustment information regarding the adjustment values being set by said setting part and the image data to be a print target to said printing device, and said printing device comprises:
an adjusting part that can adjust the image quality of the image data outputted from said data outputting part based on said image quality adjustment information; and
a printing part that can print the image data of the image quality adjusted by said adjusting part.
